(19) United States
(12) Patent Application Publication
(10) Pub. No.: US 2015/0360681 A1
(43) Pub. Date: Dec. 17, 2015

(54) CONTROL APPARATUS FOR A HYBRID VEHICLE DRIVE SYSTEM

(71) Applicant: TOYOTA JIDOSHA KABUSHIKI KAISHA, Toyota-shi (JP)

(72) Inventors: Takeshi KANAYAMA, Toyota-shi (JP); Shinichi BABA, Toyota-shi (JP)

(21) Appl. No.: 14/733,390

(22) Filed: Jun. 8, 2015

(30) Foreign Application Priority Data
Jun. 13, 2014 (JP) 2014-122924

(51) Int. Cl. B60W 20/00; B60W 10/06; B60K 6/547; B60W 10/12; B60K 6/365; B60K 6/445; B60W 10/115; B60W 10/08

(52) U.S. Cl. CPC B60W 20/40; B60W 10/115; B60W 10/06; B60W 10/08; B60W 10/12; B60K 6/365; B60K 6/445; B60K 6/547; B60W 2710/021; B60W 2710/06; B60W 2710/08; B60W 2710/1005; B60W 2710/12; Y10S 903/93; Y10S 903/911; Y10S 903/919

(57) ABSTRACT

Control apparatus for hybrid vehicle drive system including a plurality of coupling elements which selectively connect selected ones of rotary components of differential device and stationary member to each other, and which permit the drive system to be placed in one of electric motor drive mode, and constant-speed-ratio drive modes in which an engine is operated as drive power source, control apparatus selectively establishing one of hybrid drive mode and electric motor drive mode, with an engaging action of one of coupling elements, and one of constant-speed-ratio drive modes, with an engaging action of another coupling element as well as or in place of engaging action of above-indicated one coupling element, control apparatus including drive mode switching portion configured to establish one of hybrid drive mode and electric motor drive mode, when drive system is required to be switched from neutral state to a vehicle drive state.

### CROSS REFERENCE TO RELATED APPLICATION

The present application claims the priority from Japanese Patent Application No. 2014-122924 filed on Jun. 13, 2014, the disclosure of which is herein incorporated by reference in its entirety.

### BACKGROUND OF THE INVENTION

1. Field of The Invention

The present invention relates to an improvement of a control apparatus for a drive system of a hybrid vehicle.

2. Description of Related Art

There is known a hybrid vehicle drive system including: a differential device which comprises a first differential mechanism and a second differential mechanism and which comprises four rotary components; an engine, a first electric motor, a second electric motor and an output rotary member which are respectively connected to the four rotary components; and a plurality of coupling elements which selectively connect selected ones of the rotary components or one of the rotary components and a stationary member to each other, and which permit the hybrid vehicle drive system to be placed in a selected one of a plurality of electric motor drive modes in which at least one of the first and second electric motors is operated as a vehicle drive power source, and a plurality of constant-speed-ratio drive modes in which the engine is operated as the vehicle drive power source and which have respective different speed ratio values. JP-2013-039906 A1 discloses an example of such hybrid vehicle drive system, which is configured to selectively establish the above-indicated plurality of electric motor drive modes, the above-indicated plurality of constant-speed-ratio drive modes, and a plurality of hybrid drive modes, according to respective different combinations of operating states (engaged and released states) of the above-indicated plurality of coupling elements.

By the way, at least one of the coupling elements is required to be brought into an engaged state, to switch the above-described prior art hybrid vehicle drive system from a neutral state (so-called “N” position) in which a drive force is not transmitted through a power transmitting path with none of the coupling elements being placed in engaged states, to any vehicle drive state (such as a so-called “D” position) in which the drive force is transmitted through the power transmitting path. Accordingly, there is a risk of generation of an engaging shock of the coupling element to be brought into the engaged state, namely, a drive mode switching shock of the hybrid vehicle drive system. The hybrid vehicle drive system is placed in the vehicle drive state when any one of the above-described electric motor drive modes, hybrid drive modes and constant-speed-ratio drive modes is established. To place the hybrid vehicle drive system in the vehicle drive state by establishing one of the constant-speed-ratio drive modes, in particular, engaging actions of at least two of the plurality of coupling elements, for instance, two coupling elements are required to be accurately controlled so as to be synchronized with each other. In this respect, the risk of generation of the drive mode switching shock is considered to be relatively high.

### SUMMARY OF THE INVENTION

It is therefore an object of the present invention to provide a control apparatus for a hybrid vehicle drive system, which permits reduction of the risk of generation of the drive mode switching shock when the hybrid vehicle drive system is required to be placed in the vehicle drive state in which the drive force is transmitted through the power transmitting path.

The present inventor made an intensive study in view of the above-described prior art hybrid vehicle drive system including: a differential device which comprises a first differential mechanism and a second differential mechanism and which comprises four rotary components; an engine, a first electric motor, a second electric motor and an output rotary member which are respectively connected to the four rotary components; and a plurality of coupling elements which selectively connect selected ones of the rotary components or one of the rotary components and a stationary member to each other, and which permit the hybrid vehicle drive system to be placed in a selected one of a plurality of electric motor drive modes in which at least one of the first and second electric motors is operated as a vehicle drive power source, and a plurality of constant-speed-ratio drive modes in which the engine is operated as the vehicle drive power source and which have respective different speed ratio values. The present inventor paid a particular attention to a fact that the plurality of electric motor drive modes are selectively established depending upon an operating state of one of the plurality of coupling elements, while the plurality of constant-speed-ratio drive modes are selectively established according to respective combinations of the engaged states of two of the coupling elements. The study revealed that when the hybrid vehicle drive system is switched from the neutral state in which the drive force is not transmitted through the power transmitting path with none of the coupling elements being placed in the engaged states, to any vehicle drive state (for running of the hybrid vehicle in a loaded state) in which the drive force is transmitted through the power transmitting path, the engaging shock due to an engaging action of the above-indicated one coupling element can be effectively reduced by establishing any one of the hybrid drive modes in which the hybrid vehicle drive system functions as an electrically controlled continuously variable transmission, or any one of the electric motor drive modes in which the engine is not operated. In particular, the study revealed that when the hybrid vehicle drive system is switched from the neutral state to any one of the constant-speed-ratio drive modes for running of the hybrid vehicle at a specific speed ratio value, the engaging shocks of the coupling elements can be effectively reduced by once establishing one of the electric motor drive modes or hybrid drive modes with an engaging action of the above-indicated one coupling element, and then eventually establishing one of the constant-speed-ratio drive modes with an engaging action of another of the coupling elements as well as the engaging action of the above-indicated one coupling element.

The object indicated above is achieved according to the principle of the present invention, which provides a control apparatus for a drive system of a hybrid vehicle including: a differential device which comprises a first differential mechanism and a second differential mechanism and which comprises four rotary components; an engine, a first electric motor, a second electric motor and an output rotary member which are respectively connected to the four rotary components; and a plurality of coupling elements which selectively connect selected ones of the rotary components or one of the rotary components and a stationary member to each other, and which permit the hybrid vehicle drive system to be placed in a selected one of an electric motor drive mode in which at least one of the first and second electric motors is operated as a vehicle drive power source, and a plurality of constant-speed-ratio drive modes in which the engine is operated as the vehicle drive power source and which have respective different speed ratio values, the control apparatus being configured to selectively establish one of a hybrid drive mode and the electric motor drive mode, with an engaging action of one of the plurality of coupling elements, and one of the plurality of constant-speed-ratio drive modes, with an engaging action of another of the plurality of coupling elements as well as or in place of the engaging action of the above-described one coupling element, the control apparatus comprising a drive mode switching portion configured to establish one of the hybrid drive mode and the electric motor drive mode, when the drive system is required to be switched from a neutral state in which a drive force is not transmitted through a power transmitting path with all of the plurality of coupling elements being placed in released states, to a vehicle drive state in which the drive force is transmitted through the power transmitting path.

The control apparatus according to the present invention described above is configured to establish one of the hybrid drive mode and the electric motor drive mode with an engaging action of one of the plurality of coupling elements, when the drive system is required to be switched from the neutral state to any vehicle drive state while the hybrid vehicle is held stationary or running. Described more specifically, where the drive system is required to be switched from the neutral state to the vehicle drive state while the engine is operated, an engaging action of one of the coupling elements permits the drive system to be placed in the hybrid drive mode in which the drive system is operated as an electrically controlled continuously variable transmission, at a speed ratio at which the engaging action of the relevant coupling element is easily coordinated with an operating speed of the engine and can be performed with a reduced amount of engaging shock. Where the drive system is required to be switched from the neutral state to the vehicle drive state while the engine is held at rest, an engaging action of one of the coupling elements permits the drive system to be placed in the electric motor drive mode in which the engaging action of the relevant coupling element is not required to be coordinated with the operating speed of the engine. Accordingly, the risk of generation of the engaging shock of the relevant coupling element upon switching of the drive system from the neutral state to any vehicle drive state can be effectively reduced.

In a first preferred form of the invention, the drive mode switching portion establishes the hybrid drive mode when the drive system is required to be switched from the neutral state to the vehicle drive state while the engine is operated. According to this first preferred form of the invention, where the drive system is required to be switched from the neutral state to the vehicle drive state while the engine is operated, one of the coupling elements is brought into an engaged state to place the drive system in the hybrid drive mode in which the drive system is operated as an electrically controlled continuously variable transmission, at a speed ratio at which the engaging action of the relevant coupling element is easily coordinated with an operating speed of the engine and can be performed with a reduced amount of engaging shock. Accordingly, the risk of generation of the engaging shock of the relevant coupling element upon switching of the drive system from the neutral state to any vehicle drive state can be effectively reduced.

In a second preferred form of the invention, the drive mode switching portion establishes the electric motor drive mode when the drive system is required to be switched from the neutral state to the vehicle drive state while the engine is held at rest. According to this second preferred form of the invention, where the drive system is required to be switched from the neutral state to the vehicle drive state while the engine is held at rest, one of the coupling elements is brought into an engaged state to place the drive system in the electric motor drive mode in which the engaging action of the relevant coupling element is not required to be coordinated with the operating speed of the engine. Accordingly, the risk of generation of the engaging shock of the relevant coupling element upon switching of the drive system from the neutral state to any vehicle drive state can be effectively reduced.

In a third preferred form of the invention, when the drive system is required to be switched from the neutral state to one of the plurality of constant-speed-ratio drive modes, the drive mode switching portion once establishes one of the electric motor drive mode and the hybrid drive mode, and then eventually establishes the above-indicated one of the plurality of constant-speed-ratio drive modes. According to this third preferred form of the invention wherein the drive system which is required to be switched to one of the constant-speed-ratio drive modes is once placed in one of the electric motor drive mode and the hybrid drive mode, before the drive system is eventually placed in the required constant-speed-ratio drive mode, so that the engaging shock upon initial switching of the drive system to the above-indicated one of the electric motor drive mode and the hybrid drive mode can be reduced, and the engaging shock upon subsequent switching of the drive system to the required constant-speed-ratio drive mode with the engaging action of the above-indicated another coupling element can also be reduced since the engaging action of the above-indicated another coupling element can be easily synchronized with the synchronous control by the first electric motor and/or the second electric motor.

In a fourth preferred form of the invention, the hybrid drive mode includes a first hybrid drive mode and a second hybrid drive mode, and the electric motor drive mode includes a first electric motor drive mode and a second electric motor drive mode, while the plurality of constant-speed-ratio drive modes include a first speed constant-speed-ratio drive mode, a second speed constant-speed-ratio drive mode, a third speed constant-speed-ratio drive mode, and a fourth speed constant-speed-ratio drive mode, which have respective different speed ratio values which decrease in a direction from the first speed constant-speed-ratio drive mode toward the fourth speed constant-speed-ratio drive mode. Further, the plurality of coupling elements include: a first coupling element which is placed in an engaged state to establish the first hybrid drive mode while the engine is operated, and the first electric motor drive mode while the engine is held at rest; a second coupling element which is placed in an engaged state to establish the second hybrid drive mode while the engine is operated, and the second electric motor drive mode while the engine is held at rest; a third coupling element which is placed in an engaged state in the engaged state of the first coupling element, to establish the first speed constant-speed-ratio drive mode, and in an engaged state of the second coupling element, to establish the third speed constant-speed-ratio drive mode; and a fourth coupling element which is placed in an engaged state in the engaged state of the first coupling element, to establish the second speed constant-speed-ratio drive mode, and in the engaged state of the second coupling element, to establish the fourth speed constant-speed-ratio drive mode. According to this fourth preferred form of the invention, the drive system is switched from the neutral state to one of the hybrid drive mode and the electric motor drive mode, with an engaging action of the first or second coupling element, depending upon whether the engine is operated or held at rest, and to one of the first through fourth speed constant-speed-ratio drive modes, with engaging actions of a corresponding one of four combinations of two coupling elements one of which is selected from the first and second coupling elements and the other of which is selected from the third and fourth coupling elements.

In a fifth preferred form of the invention, (a) each of the first differential mechanism and the second differential mechanism includes three rotary elements, and the first and second differential mechanisms are configured such that one of the three rotary elements of the first differential mechanism and one of the three rotary elements of the second differential mechanism are connected to each other, (b) the engine and the first electric motor are respectively connected to two rotary elements of the three rotary elements of the first differential mechanism, which two rotary elements are not connected to the above-indicated one of the three rotary elements of the second differential mechanism, (c) the second electric motor is connected to the above-indicated one of the three rotary elements of the second differential mechanism, (d) the output rotary member is connected to one of two rotary elements of the second differential mechanism, which two rotary elements are not connected to the above-indicated one of the three rotary elements of the first differential mechanism, (e) the plurality of coupling elements include: a first clutch element for selectively connecting the two rotary elements of the three rotary elements of the first differential mechanism to each other; a second clutch element for selectively connecting the rotary element of the first differential mechanism connected to the engine and the other of the two rotary elements of the second differential mechanism to each other; a first brake element for selectively connecting the rotary element of the first differential mechanism connected to the first electric motor to a stationary member; and a second brake element for selectively connecting the other of the two rotary elements of the second differential mechanism to the stationary member, and (f) the drive mode switching portion establishes a first one of the electric motor drive modes with an engaging action of the second clutch element, establishes a second one of the electric motor drive modes with an engaging action of the second brake element, establishes a first-speed one of the constant-speed-ratio drive modes with engaging actions of the first clutch element and the second brake element, establishes a second-speed one of the constant-speed-ratio drive modes with engaging actions of the first brake element and the second brake element, establishes a third-speed one of the constant-speed-ratio drive modes with engaging actions of the first clutch element and the second clutch element, and establishes a fourth-speed one of the constant-speed-ratio drive modes with engaging actions of the second clutch element and the first brake element.

According to the above-described fifth preferred form of the invention, the first one of the electric motor drive modes is once established when the drive system is required to establish the motor drive mode during the first speed one or the second speed one of the constant-speed-ratio drive modes, and the second one of the electric motor drive modes is once established when the drive system is required to establish the motor drive mode during the third speed one or the fourth speed one of the constant-speed-ratio drive modes. Thus, the first one or the second one of the electric motor drive modes is once established with a releasing action of only one coupling element when the drive system is in the first, second, third or fourth speed one of the constant-speed-ratio drive modes. Accordingly, the drive system can be smoothly and rapidly switched from the first, second, third or fourth speed one of the constant-speed-ratio drive modes in which the hybrid vehicle is driven by the engine operated as a vehicle drive power source in response to a request for the motor drive mode, so that deterioration of drivability of the hybrid vehicle upon switching of the drive system to the desired constant-speed-ratio drive mode can be reduced.

### BRIEF DESCRIPTION OF THE DRAWINGS

FIG. 1 is a schematic view showing an arrangement of a hybrid vehicle drive system to which the present invention is suitably applicable;

FIG. 2 is a block diagram illustrating major portions of a control system provided to control the hybrid vehicle drive system of FIG. 1;

FIG. 3 is a table indicating combinations of operating states of clutches and brakes, which correspond to respective vehicle drive modes to be established in the hybrid vehicle drive system of FIG. 1;

FIG. 4 is a collinear chart having straight lines which permit indication thereon of relative rotating speeds of various rotary elements of the drive system of FIG. 1, the collinear chart corresponding to a first hybrid drive mode HV1 and a first electric motor drive mode EV1 indicated in FIG. 3;

FIG. 5 is a collinear chart having straight lines which permit indication thereon of the relative rotating speeds of the rotary elements of the drive system of FIG. 1, the collinear chart corresponding to a second hybrid drive mode HV2 indicated in FIG. 3;

FIG. 6 is a collinear chart having straight lines which permit indication thereon of the relative rotating speeds of the rotary elements of the drive system of FIG. 1, the collinear chart corresponding to a second electric motor drive mode EV2 indicated in FIG. 3;

FIG. 7 is a collinear chart having straight lines which permit indication thereon of the relative rotating speeds of the rotary elements of the drive system of FIG. 1, the collinear chart corresponding to a constant-speed-ratio drive mode “1st-speed” indicated in FIG. 3;

FIG. 8 is a collinear chart having straight lines which permit indication thereon of the relative rotating speeds of the rotary elements of the drive system of FIG. 1, the collinear chart corresponding to a constant-speed-ratio drive mode “2nd-speed” indicated in FIG. 3;

FIG. 9 is a collinear chart having straight lines which permit indication thereon of the relative rotating speeds of the rotary elements of the drive system of FIG. 1, the collinear chart corresponding to a constant-speed-ratio drive mode “3rd-speed” indicated in FIG. 3;

FIG. 10 is a collinear chart having straight lines which permit indication thereon of the relative rotating speeds of the rotary elements of the drive system of FIG. 1, the collinear chart corresponding to a constant-speed-ratio drive mode “4th-speed” indicated in FIG. 3;

FIG. 11 is a functional block diagram illustrating major control functions of an electronic control device shown in FIG. 2;

FIG. 12 is a flow chart illustrating a major portion of one example of a drive mode switching control implemented by the electronic control device shown in FIG. 2; and

FIG. 13 is a flow chart illustrating a major portion of another example of the drive mode switching control implemented by the electronic control device shown in FIG. 2.

### DETAILED DESCRIPTION OF PREFERRED EMBODIMENTS

In the hybrid vehicle drive system to be controlled by the control apparatus according to the present invention, the differential device comprising the first differential mechanism and the second differential mechanism comprises the four rotary components when the above-described clutch disposed between a rotary element of the first differential mechanism and a rotary element of the second differential mechanisms is placed in an engaged state. Preferably, the differential device comprises the four rotary components when the clutch disposed between a second rotary element of the first differential mechanism and a first rotary element of the second differential mechanism is placed in the engaged state. In other words, the present invention is suitably applicable to a hybrid vehicle drive system including: a differential device comprising a first differential mechanism and a second differential mechanism and comprising four rotary components relative rotating speeds of which are represented along a vertical axis in a two-dimensional collinear chart in which relative gear ratios of the first and second differential mechanisms are taken along a horizontal axis; and an engine, a first electric motor, a second electric motor and an output rotary member which are respectively connected to the four rotary components, and wherein one of the four rotary components is constituted by a rotary element of the first differential mechanism and a rotary element of the second differential mechanism which are selectively connected to each other through a clutch, while one of the rotary elements of the first and second differential mechanisms which are selectively connected to each other through the clutch is selectively connected to a stationary member through a brake.

Each of the above-described clutch and brake is preferably a hydraulically operated coupling device (coupling element) the operating state (engaging and releasing actions) of which is (are) controlled according to a hydraulic pressure applied thereto. While wet multiple-disc type frictional coupling devices are suitably used as the coupling devices, meshing type coupling devices such as so-called “dog clutches” (claw clutches), and electromagnetic clutches, magnetic powder clutches or any other coupling devices the operating states of which are controlled according to electric commands may be used.

Referring to the drawings, a preferred embodiment of the present invention will be described in detail. It is to be understood that the drawings referred to below do not necessarily accurately represent ratios of dimensions of various elements.

### Embodiment

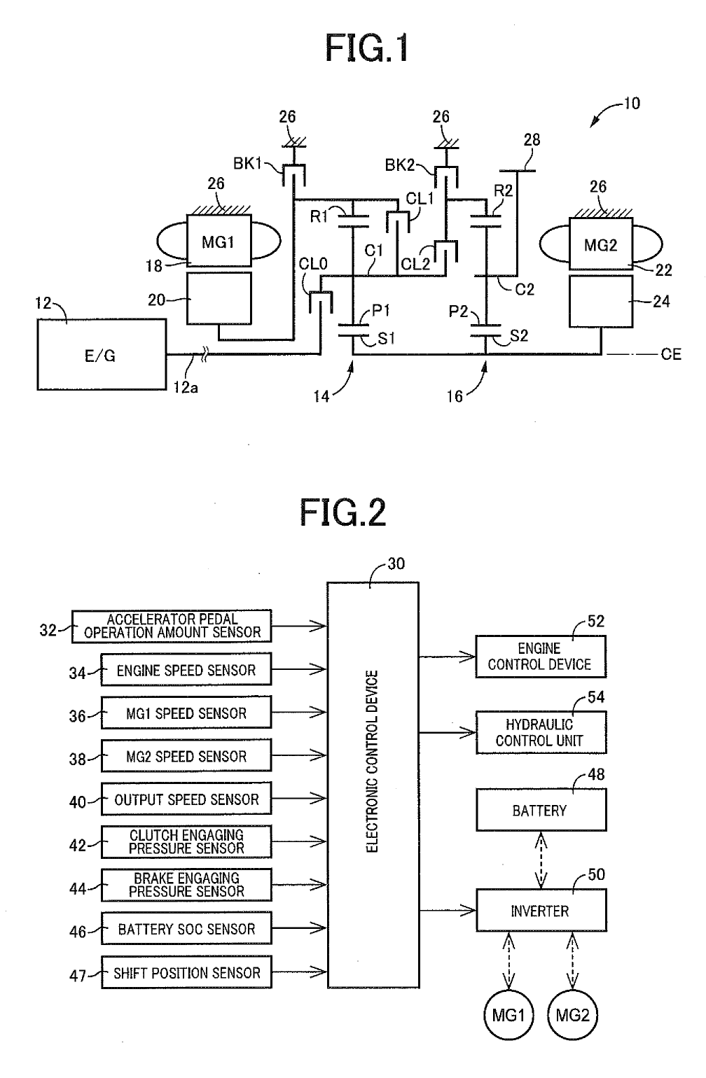

FIG. 1 is the schematic view showing an arrangement of a hybrid vehicle drive system 10 (hereinafter referred to simply as a “drive system 10”) to which the present invention is suitably applicable. As shown in FIG. 1, the drive system 10 according to the present embodiment is of a transversely installed type suitably used for an FF (front-engine front-drive) type vehicle, and is provided with a main vehicle drive power source in the form of an engine 12, a first electric motor MG1, a second electric motor MG2, a first differential mechanism in the form of a first planetary gear set 14, and a second differential mechanism in the form of a second planetary gear set 16, which are disposed on a common axis CE. In the following description of the embodiment, the direction of extension of this axis CE will be referred to as an “axial direction”. The drive system 10 is constructed substantially symmetrically with respect to the axis CE. In FIG. 1, a lower half of the drive system 10 is not shown.

The engine 12 is an internal combustion engine such as a gasoline engine, which is operable to generate a drive force by combustion of a fuel such as a gasoline injected into its cylinders. Each of the first and second electric motors MG1 and MG2 is a so-called motor/generator having a function of a motor operable to generate a drive force, and a function of an electric generator operable to generate a reaction force, and is provided with a stator 18, 22 connected to a stationary member in the form of a housing (casing) 26, and a rotor 20, 24 disposed radially inwardly of the stator 18, 22.

The first planetary gear set 14 is a single-pinion type planetary gear set which has a gear ratio ρ1 and which includes three rotary elements consisting of a first rotary element in the form of a ring gear R1; a second rotary element in the form of a carrier C1 supporting a pinion gear P1 such that the pinion gear P1 is rotatable about its axis and the axis of the planetary gear set; and a third rotary element in the form of a sun gear S1 meshing with the ring gear R1 through the pinion gear P1. The second planetary gear set 16 is a single-pinion type planetary gear set which has a gear ratio ρ2 and which includes three rotary elements consisting of; a first rotary element in the form of a ring gear R2; a second rotary element in the form of a carrier C2 supporting a pinion gear P2 such that the pinion gear P2 is rotatable about its axis and the axis of the planetary gear set; and a third rotary element in the form of a sun gear S2 meshing with the ring gear R2 through the pinion gear P2.

In the first planetary gear set 14, the ring gear R1 is connected to the rotor 20 of the first electric motor MG1, and the carrier C1 is selectively connectable through a clutch CL0 to an output shaft of the engine 12 in the form of a crankshaft 12a, while the sun gear S1 is connected to the sun gear S2 of the second planetary gear set 16 and the rotor 24 of the second electric motor MG2. In the second planetary gear set 16, the carrier C2 is connected to an output rotary member in the form of an output gear 28. A drive force received by the output gear 28 is transmitted to a pair of right and left drive wheels (not shown) through a differential gear device and axles (not shown). A torque received by the drive wheels from a roadway surface during running of the hybrid vehicle is transmitted from the output gear 28 to the drive system 10 through the differential gear device and axles.

The clutch CL0 for selectively connecting and disconnecting the carrier C1 of the first planetary gear set 14 to and from the crankshaft 12a of the engine 12 is disposed between the crankshaft 12a and the carrier C1. A clutch CL1 for selectively connecting and disconnecting the carrier C1 to and from the ring gear R1 is disposed between the carrier C1 and the ring gear R1. A clutch CL2 for selectively connecting and disconnecting the carrier C1 to and from the ring gear R2 of the second planetary gear set 16 is disposed between the carrier C1 and the ring gear R2. A brake BK1 for selectively connecting the ring gear R1 to the stationary member in the form of the housing 26 is disposed between the ring gear R1 and the housing 26. A brake BK2 for selectively connecting (fixing) the ring gear R2 to the housing 26 is disposed between the ring gear R2 and the housing 26.

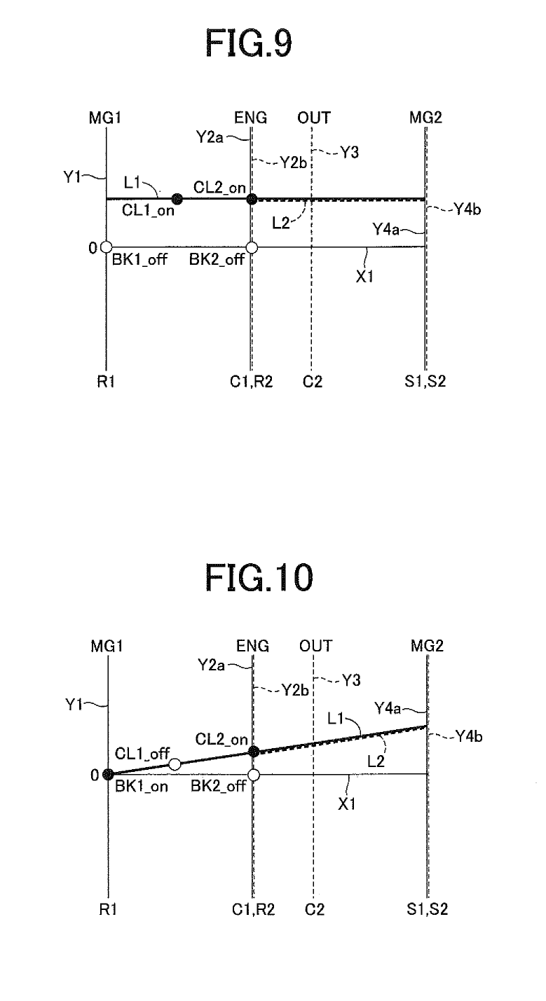

In the drive system 10, the differential device comprising the first and second planetary gear sets 14 and 16 comprises four rotary components when the clutch CL2 is placed in an engaged state. In other words, the drive system 10 includes: the differential device comprising the first planetary gear set 14 and the second planetary gear set 16 and comprising the four rotary components the relative rotating speeds of which are represented along a vertical axis in each of two-dimensional collinear charts of FIGS. 4-10 referred to below, in which the relative gear ratios of the first and second planetary gear sets 14 and 16 are taken along a horizontal axis; and the engine 12, the first electric motor MG1, the second electric motor MG2 and the output gear 28, which are respectively connected to the above-indicated four rotary components. One of the four rotary components is constituted by the carrier C1 of the first planetary gear set 14 and the ring gear R2 of the second planetary gear set 16 which are selectively connected to each other through the clutch CL2, while the ring gear R2 selectively connected to the carrier C1 through the clutch CL2 is selectively connected to the housing 26 through the brake BK2.

In the present drive system 10, the clutch CL0 need not be provided. That is, the crankshaft 12a of the engine 12 may be connected to the carrier C1 of the first planetary gear set 14 through a damper, for example, without the clutch CL0 being disposed therebetween.

The operating states (engaging and releasing actions) of the clutches CL1 and CL2 and the brakes BK1 and BK2 which function as coupling elements are controlled according to the hydraulic pressure applied from a hydraulic control unit 54. While wet multiple-disc type frictional coupling devices are suitably used as the coupling devices, meshing type coupling devices such as so-called “dog clutches” (claw clutches), and electromagnetic clutches, magnetic powder clutches or any other coupling devices the operating states of which are controlled according to electric commands generated from an electronic control device 30 may be used.

FIG. 2 is the block diagram illustrating major portions of a control system provided to control the drive system 10. The electronic control device 30 shown in FIG. 2 is a so-called microcomputer which incorporates a CPU, a ROM, a RAM and an input-output interface and which is operable to perform signal processing operations according to programs stored in the ROM while utilizing a temporary data storage function of the RAM, to implement various drive controls of the drive system 10, such as a drive control of the engine 12 and hybrid drive controls of the first and second electric motors MG1 and MG2. In the present embodiment, the electronic control device 30 serves as a control apparatus for the drive system 10. The electronic control device 30 may be constituted by mutually independent control units as needed for respective controls such as an output control of the engine 12 and drive controls of the first and second electric motors MG1 and MG2.

As indicated in FIG. 2, the electronic control device 30 is configured to receive various output signals from various sensors and switches provided in the drive system 10. Namely, the electronic control device 30 receives: an output signal of an accelerator pedal operation amount sensor 32 indicative of an operation amount or angle Acc of an accelerator pedal (not shown), which corresponds to a vehicle output required by a vehicle operator; an output signal of an engine speed sensor 34 indicative of an engine speed N_{E} (rpm), that is, an operating speed of the engine 12; an output signal of an MG1 speed sensor 36 indicative of an operating speed N_{MG1} (rpm) of the first electric motor MG1; an output signal of an MG2 speed sensor 38 indicative of an operating speed N_{MG2} (rpm) of the second electric motor MG2; an output signal of a running speed detector in the form of an output speed sensor 40 indicative of a rotating speed N_{OUT} (rpm) of the output gear 28, which corresponds to a running speed V of the hybrid vehicle; an output signal of a clutch engaging pressure sensor 42 indicative of a hydraulic pressure P_{CL1} (N/m²) applied to the clutch CL1; an output signal of a brake engaging pressure sensor 44 indicative of a hydraulic pressure P_{BK1} (N/m²) applied to the brake BK1; an output signal of a battery SOC sensor 46 indicative of a stored electric energy amount (state of charge) SOC of a battery 48; and an output signal of a shift position sensor 47 indicative of a presently selected operating position (shift position) of a manually operated shifting device (a shift lever).

The electronic control device 30 is also configured to generate various control commands to be applied to various portions of the drive system 10. Namely, the electronic control device 30 applies, to an engine control device 52, engine output control commands for controlling the output of the engine 12, which commands include: a fuel injection amount control signal to control an amount of injection of a fuel by a fuel injecting device into an intake pipe; an ignition control signal to control a timing of ignition of the engine 12 by an igniting device; and an electronic throttle valve drive control signal to control a throttle actuator for controlling an opening angle θ_{TH} of an electronic throttle valve. Further, the electronic control device 30 applies command signals to an inverter 50, for controlling operations of the first and second electric motors MG1 and MG2, so that the first and second electric motors MG1 and MG2 are operated with electric energies supplied thereto from the battery 48 through the inverter 50 according to the command signals to control outputs (output torques) of the electric motors MG1 and MG2. Electric energies generated by the first and second electric motors MG1 and MG2 are supplied to and stored in the battery 48 through the inverter 50. Further, the electronic control device 30 applies command signals for controlling the operating states of the clutches CL0, CL1 and CL2 (hereinafter referred to as “clutches CL”, unless otherwise specified) and brakes BK1 and BK2 (hereinafter referred to as “brakes BK”, unless otherwise specified), to electromagnetic control valves such as linear solenoid valves provided in the hydraulic control unit 54, so that hydraulic pressures generated by those electromagnetic control valves are controlled to control the operating states of the clutches CL and brakes BK.

An operating state of the drive system 10 is controlled through the first and second electric motors MG1 and MG2, such that the drive system 10 functions as an electrically controlled differential portion whose difference of input and output speeds is controllable. For example, the electric energy generated by the first electric motor MG1 is supplied to the battery 48 or the second electric motor MG2 through the inverter 50. Namely, a major portion of the drive force of the engine 12 is mechanically transmitted to the output gear 28, while the remaining portion of the drive force is consumed by the first electric motor MG1 operating as the electric generator, and converted into the electric energy, which is supplied to the second electric motor MG2 through the inverter 50, so that the second electric motor MG2 is operated to generate a drive force to be transmitted to the output gear 28. Components associated with the generation of the electric energy and the consumption of the generated electric energy by the second electric motor MG2 constitute an electric path through which a portion of the drive force of the engine 12 is converted into an electric energy which is converted into a mechanical energy.

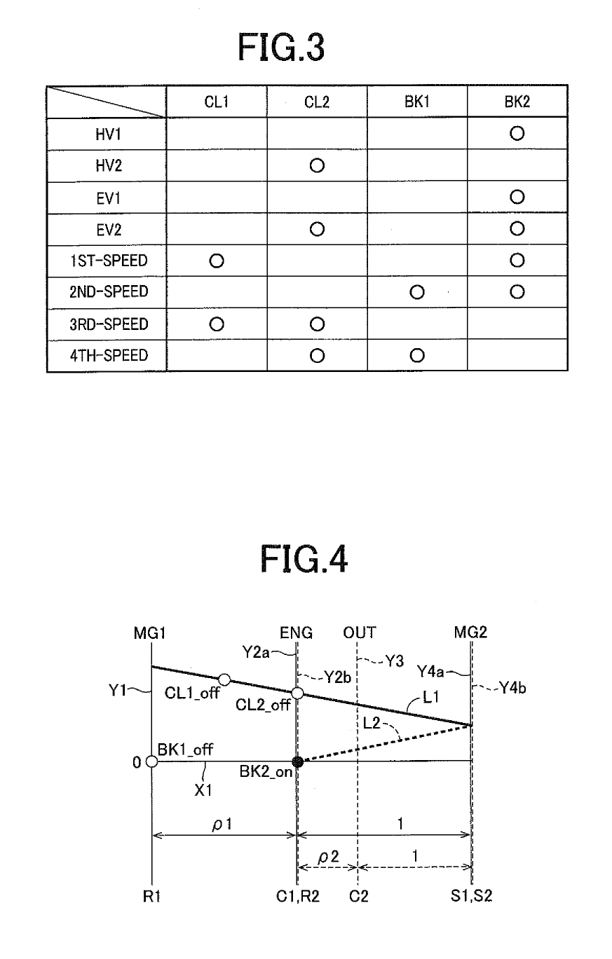

In the hybrid vehicle provided with the drive system 10 constructed as described above, a selected one of a plurality of vehicle drive modes is established according to the operating states of the engine 12 and the first and second electric motors MG1 and MG2, and the operating states of the clutches CL and brakes BK. FIG. 3 is the table indicating combinations of the operating states of the clutches CL1 and CL2 and the brakes BK1 and BK2, which correspond to the respective eight vehicle drive modes of the drive system 10. In this table, “o” marks represent the engaged states of the clutches CL and brakes BK while blanks represent their released states. Hybrid drive modes HV1 and HV2 indicated in FIG. 3 are HV drive modes in which the engine 12 is operated as the vehicle drive power source while the first and second electric motors MG1 and MG2 are operated as needed to generate a vehicle drive force and/or an electric energy, so that the drive system 10 is operable as an electrically controlled continuously variable transmission. In these hybrid drive modes HV1 and HV2, at least one of the first and second electric motors MG1 and MG2 can be operated to generate a reaction force or placed in a non-loaded free state. Electric motor drive modes EV1 and EV2 are EV drive modes in which the engine 12 is held at rest while at least one of the first and second electric motors MG1 and MG2 is used as the vehicle drive power source. Constant-speed-ratio drive modes “1st-speed” through “4th-speed” are drive modes which are established when the differential functions of the first and second planetary gear sets 14 and 16 are limited, and in which the ratios of the output speeds of the first and second planetary gear sets 14 and 16 to the speed of the rotary motion received from the engine 12 are held constant. The above-indicated speed ratios in the constant-speed-ratio drive modes “1st-speed” through “4th-speed” decrease in a direction from the drive mode “1st-speed” toward the drive mode “4th-speed”.

In the drive system 10, the clutch CL1 and the brake BK1 are both placed in the released states, as indicated in FIG. 3, to permit the first planetary gear set 14 to perform the differential function with respect to the rotary motion received from the engine 12, in the hybrid drive modes HV1 and HV2 in which the engine 12 is operated as the vehicle drive power source while the first and second electric motors MG1 and MG2 are operated as needed to generate a drive force and/or an electric energy. The hybrid drive mode HV1 is established when the brake BK2 is placed in the engaged state while the clutch CL2 is placed in the released state, and the hybrid drive mode HV2 is established when the brake BK2 is placed in the released state while the clutch CL2 is placed in the engaged state.

The clutch CL1 and the brake BK1 are both placed in the released states, to permit the first planetary gear set 14 to perform the differential function with respect to the rotary motion received from the engine 12, in the electric motor drive modes EV1 and EV2 in which at least one of the first and second electric motors MG1 and MG2 is operated as the vehicle drive power source while the engine 12 is held at rest. The electric motor drive mode EV1 is established when the brake BK2 is placed in the engaged state while the clutch CL2 is placed in the released state, and the electric motor drive mode EV2 is established when the brake BK2 and the clutch CL2 are both placed in the engaged states.

In the constant-speed-ratio drive modes “1st-speed” through “4th-speed” in which the ratios of the output speeds of the first and second planetary gear sets 14 and 16 to the speed of the rotary motion received from the engine 12 are held constant, either one of the clutch CL1 and the brake BK1 is placed in the engaged state to limit the differential function of the first planetary gear set 14 with respect to the rotary motion received from the engine 12. The constant-speed-ratio drive mode “1st-speed” which is a first-speed drive mode having the highest speed ratio value is established when the clutch CL1 and the brake BK2 are placed in the engaged states while the clutch CL2 and the brake BK1 are placed in the released states. The constant-speed-ratio drive mode “2nd-speed” which is a second-speed drive mode having a speed ratio value lower than that of the constant-speed-ratio drive mode “1st-speed” is established when the clutches CL1 and CL2 are placed in the released states while the brakes BK1 and BK2 are placed in the engaged states. The constant-speed-ratio drive mode “3rd-speed” which is a third-speed drive mode having a speed ratio value lower than that of the constant-speed-ratio drive mode “2nd-speed” is established when the clutches CL1 and CL2 are placed in the engaged states while the brakes BK1 and BK2 are placed in the released states. The constant-speed-ratio drive mode “4th-speed” which is a fourth-speed drive mode having the lowest speed ratio value is established when the clutch CL1 and the brake BK2 are placed in the released states while the clutch CL2 and the brake BK1 are placed in the engaged states.

FIGS. 4-10 are the collinear charts having straight lines which permit indication thereon of the relative rotating speeds of the various rotary components of the drive system 10 (rotary elements of the first and second planetary gear sets 14 and 16), in respective different states of connection of the rotary elements corresponding to the respective different combinations of the operating states of the clutches CL1 and CL2 and the brakes BK1 and BK2. These collinear charts are defined in a two-dimensional coordinate system having a horizontal axis along which the relative gear ratios p of the first and second planetary gear sets 14 and 16 are taken, and a vertical axis along which the relative rotating speeds of the rotary elements are taken. The collinear charts indicate the relative rotating speeds when the output gear 28 is rotated in the positive direction to drive the hybrid vehicle in the forward direction. A horizontal line X1 represents the rotating speed of zero, while vertical lines Y1, Y2a, Y2b, Y3, Y4a and Y4b arranged in the order of description in the rightward direction represent the respective relative rotating speeds of the various rotary elements. Namely, a solid line Y1 represents the rotating speed of the ring gear R1 of the first planetary gear set 14 (first electric motor MG1), and a solid line Y2a represents the rotating speed of the carrier C1 of the first planetary gear set 14 (engine 12), while a broken line Y2b represents the rotating speed of the ring gear R2 of the second planetary gear set 16. A broken line Y3 represents the rotating speed of the carrier C2 of the second planetary gear set 16 (output gear 28), and a solid line Y4a represents the rotating speed of the sun gear S1 of the first planetary gear set 14, while a broken line Y4b represents the rotating speed of the sun gear S2 of the second planetary gear set 16 (second electric motor MG2). In FIGS. 4-10, the vertical lines Y2a and Y2b are superimposed on each other, while the vertical lines Y4a and Y4b are superimposed on each other. Since the sun gears S1 and S2 are connected to each other, the relative rotating speeds of the sun gears S1 and S2 represented by the vertical lines Y4a and Y4b are equal to each other.

In FIGS. 4-10, a solid line L1 represents the relative rotating speeds of the three rotary elements of the first planetary gear set 14, while a broken line L2 represents the relative rotating speeds of the three rotary elements of the second planetary gear set 16. Distances between the vertical lines Y1-Y4 (Y2b-Y4b) are determined by the gear ratios ρ1 and ρ2 of the first and second planetary gear sets 14 and 16. Described more specifically, regarding the vertical lines Y1, Y2a and Y4a corresponding to the respective three rotary elements of the first planetary gear set 14, a distance between the vertical lines Y2a and Y4a respectively corresponding to the carrier C1 and the sun gear S1 corresponds to “1”, while a distance between the vertical lines Y1 and Y2a respectively corresponding to the ring gear R1 and the carrier C1 corresponds to the gear ratio “ρ1”. Regarding the vertical lines Y2b, Y3 and Y4b corresponding to the respective three rotary elements of the second planetary gear set 16, a distance between the vertical lines Y3 and Y4b respective corresponding to the carrier C2 and the sun gear S2 corresponds to “1”, while a distance between the vertical lines Y2b and Y3 respectively corresponding to the ring gear R2 and the carrier C2 corresponds to the gear ratio “ρ2”. The drive modes of the drive system 10 will be described by reference to FIGS. 4-10.

The collinear chart of FIG. 4 corresponds to the first hybrid drive mode HV1 of the drive system 10, which is the HV drive mode in which the engine 12 is used as the vehicle drive power source while the first and second electric motors MG1 and MG2 are operated as needed to generate a drive force and/or an electric energy. Described by reference to this collinear chart of FIG. 4, the carrier C1 of the first planetary gear set 14 and the ring gear R2 of the second planetary gear set 16 are rotatable relative to each other in the released state of the clutch CL2. In the engaged state of the brake BK2, the ring gear R2 of the second planetary gear set 16 is connected (fixed) to the stationary member in the form of the housing 26, so that the rotating speed of the ring gear R2 is held zero. In this hybrid drive mode HV1, the engine 12 is operated to generate an output torque by which the output gear 28 is rotated. At this time, the first electric motor MG1 is operated to generate a reaction torque in the first planetary gear set 14, so that the output of the engine 12 can be transmitted to the output gear 28. In the second planetary gear set 16, the carrier C2, that is, the output gear 28 is rotated in the positive direction by a positive torque (i.e., a torque acting in a positive direction) generated by the second electric motor MG2 in the engaged state of the brake BK2.

The collinear chart of FIG. 5 corresponds to the second hybrid drive mode HV2 of the drive system 10, which is the HV drive mode in which the engine 12 is used as the vehicle drive power source while the first and second electric motors MG1 and MG2 are operated as needed to generate a vehicle drive force and/or an electric energy. Described by reference to this collinear chart of FIG. 5, the carrier C1 of the first planetary gear set 14 and the ring gear R2 of the second planetary gear set 16 are not rotatable relative to each other, in the engaged state of the clutch CL2, that is, the carrier C1 and the ring gear R2 are integrally rotated as a single rotary component in the engaged state of the clutch CL2. The sun gears S1 and S2, which are connected to each other, are integrally rotated as a single rotary component. Namely, in the hybrid drive mode HV2 of the drive system 10, the first and second planetary gear sets 14 and 16 function as a differential device comprising a total of four rotary components. That is, the hybrid drive mode HV2 is a composite split mode in which the four rotary components are connected to each other in the order of description in the rightward direction as seen in FIG. 5. The four rotary components consist of: the ring gear R1 (connected to the first electric motor MG1); a rotary member consisting of the carrier C1 and the ring gear R2 connected to each other (and connected to the engine 12); the carrier C2 (connected to the output gear 28); and a rotary member consisting of the sun gears S1 and S2 connected to each other (and connected to the second electric motor MG2).

The collinear chart of FIG. 4 also corresponds to the first electric motor drive mode EV1 of the drive system 10, which is the HV drive mode in which the engine 12 is held at rest while the second electric motor MG2 is used as the vehicle drive power source. Described by reference to this collinear chart of FIG. 4, the carrier C1 of the first planetary gear set 14 and the ring gear R2 of the second planetary gear set 16 are rotatable relative to each other in the released state of the clutch CL2. Further, in the engaged state of the brake BK2, the ring gear R2 of the second planetary gear set 16 is connected (fixed) to the stationary member in the form of the housing 26, so that the rotating speed of the ring gear R2 is held zero. In this electric motor drive mode EV1, the carrier C2, that is, the output gear 28 is rotated in the positive direction by a positive torque (i.e., a torque acting in a positive direction) generated by the second electric motor MG2 in the second planetary gear set 16. Namely, the hybrid vehicle provided with the drive system 10 can be driven in the forward direction with the positive torque generated by the second electric motor MG2. In this case, the first electric motor MG1 is preferably held in a free state.

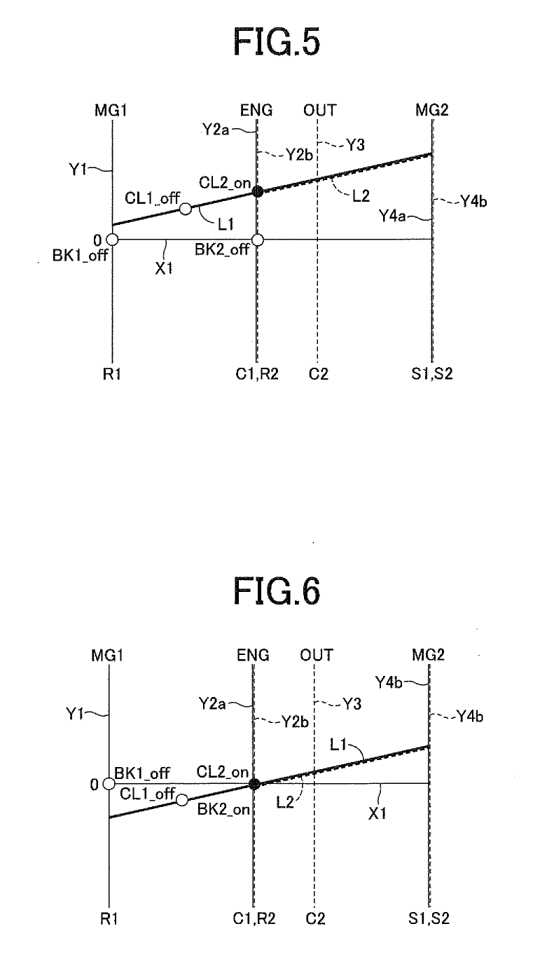

The collinear chart of FIG. 6 corresponds to the second electric motor drive mode EV2 of the drive system 10, which is the EV drive mode in which the engine 12 is held at rest while at least one of the first and second electric motors MG1 and MG2 is used as the vehicle drive power source. Described by reference to this collinear chart of FIG. 6, the carrier C1 of the first planetary gear set 14 and the ring gear R2 of the second planetary gear set 16 are not rotatable relative to each other in the engaged state of the clutch CL2. Further, in the engaged state of the brake BK2, the ring gear R2 of the second planetary gear set 16 and the carrier C1 of the first planetary gear set 14 which is connected to the ring gear R2, are connected (fixed) to the stationary member in the form of the housing 26, so that the rotating speeds of the ring gear R2 and the carrier C1 are held zero. In this electric motor drive mode EV2, the rotating directions of the ring gear R1 and the sun gear S1 of the first planetary gear set 14 are opposite to each other. Namely, the carrier C2, that is, the output gear 28 is rotated in the positive direction by a negative torque (acting in the negative direction) generated by the first electric motor MG1, and/or a positive torque (acting in the positive direction) generated by the second electric motor MG2. That is, the hybrid vehicle provided with the drive system 10 can be driven in the forward direction when the torque is generated by at least one of the first and second electric motors MG1 and MG2.

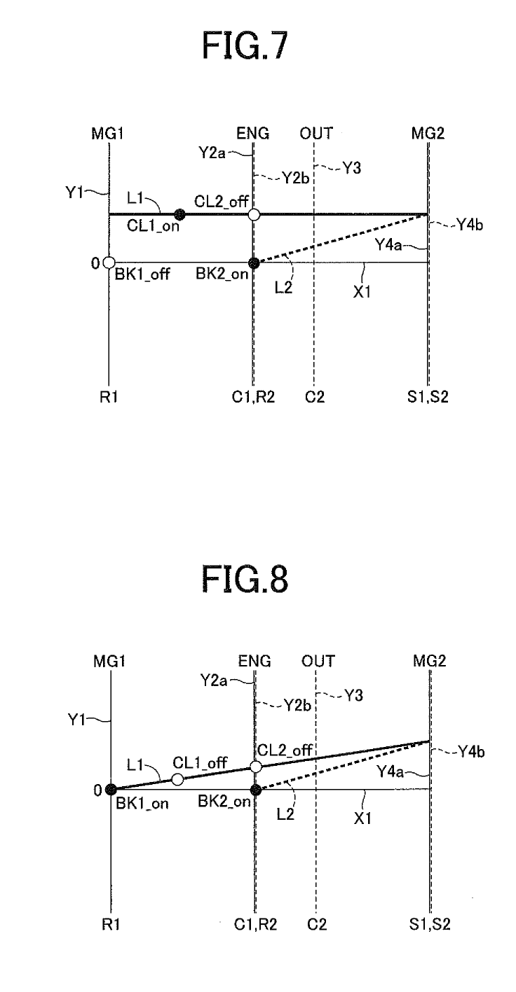

The collinear charts of FIGS. 7-10 respectively correspond to the constant-speed-ratio drive modes “1st-speed” through “4th-speed” in which the engine 12 is operated as the vehicle drive power source and which are established in the engaged states of respective different combinations of two of the four coupling elements in the form of the clutches CL1 and CL2 and the brakes BK1 and BK2. The constant-speed-ratio drive modes “1st-speed” through “4th-speed” have the respective different speed ratio values. Namely, the constant-speed-ratio drive mode “1st-speed” is established in the engaged states of the clutch CL1 and the brake BK2, and the constant-speed-ratio drive mode “2nd-speed” the speed ratio value of which is lower than that of the drive mode “1st-speed” is established in the engaged states of the brakes BK1 and BK2. The constant-speed-ratio drive mode “3rd-speed” the speed ratio value of which is lower than that of the drive mode “2nd-speed” is established in the engaged states of the clutches CL1 and CL2, and the constant-speed-ratio drive mode “4th-speed” the speed ratio value of which is lower than that of the drive mode “3rd-speed” is established in the engaged states of the clutch CL2 and the brake BK1. The speed ratio values are equal to a rotating speed NIN of the crankshaft 12a (operating speed NE of the engine 12) divided by the rotating speed N_{OUT} of the output gear 28.

Referring back to FIG. 3, the present drive system 10 is placed in a neutral state in which a drive force is not transmitted through a power transmitting path between the engine 12 and the output gear 28 in the released states of the clutches CL1 and CL2 and brakes BK1 and BK2. When the drive system 10 is switched from the neutral state to a selected one of vehicle drive states in the form of the hybrid drive modes HV1 and HV2, electric motor drive modes EV1 and EV2, and in particular, directly to the constant-speed-ratio drive modes “1st-speed” through “4th-speed”, in which the drive force is transmitted through the power transmitting path, there is a risk of generation of an engaging shock of one of the coupling elements depending upon whether the engine 12 is operated or not, even where only the above-indicated one coupling element is brought into the engaged state to establish the selected vehicle drive state. Further, the generation of the engaging shock may be inevitable where the engaging actions of the selected two coupling elements in the form of the hydraulically operated frictional coupling devices are required to be accurately controlled by controlling the first electric motor MG1 and/or the second electric motor MG2, such that the engaging actions of the two coupling elements are synchronized with each other, to establish any one of the constant-speed-ratio drive modes.

In view of the above-indicated risk, the electronic control device 30 provided in the present embodiment for controlling the drive system 10 is configured to reduce the risk of generation of the engaging shock of the coupling elements when the drive system 10 is required to be switched from the neutral state to any vehicle drive state (for running in a loaded state or acceleration of the hybrid vehicle). Described more specifically, where the selected vehicle drive state is one of the hybrid drive modes HV1 and HV2 and electric motor drive modes EV1 and EV2, which is to be established by an engaging action of one of the four coupling elements performed with a synchronous control by the first electric motor MG1 and/or the second electric motor MG2, the electronic control device 30 establishes the hybrid drive mode or the electric motor drive mode depending upon the operating state of the engine 12. Where the selected vehicle drive state is one of the constant-speed-ratio drive modes “1st-speed” through “4th-speed” which is established by engaging actions of the two coupling elements, the electronic control device 30 once establishes one of the hybrid and electric motor drive modes HV1, HV2, EV1 and EV2 which is to be established by the engaging action of one of the four coupling elements performed with the synchronous control, and then establishes the selected one of the constant-speed-ratio drive modes “1st-speed” through “4th-speed” which is established by an engaging action of another of the coupling elements performed under a synchronous control, as well as the above-indicated one coupling element. Regarding the electric motor drive mode EV2 which is established by the engaging actions of the clutch CL2 and the brake BK2, it is noted that these clutch CL2 and brake BK2 are rotated at the same speed, and therefore one of these two coupling elements can be brought into the engaged state before the other coupling element is brought into the engaged state, so that the electric motor drive mode EV2 can be established by controlling only one coupling element, that is, the above-indicated other coupling element while the above-indicated one coupling element is placed in the engaged state.

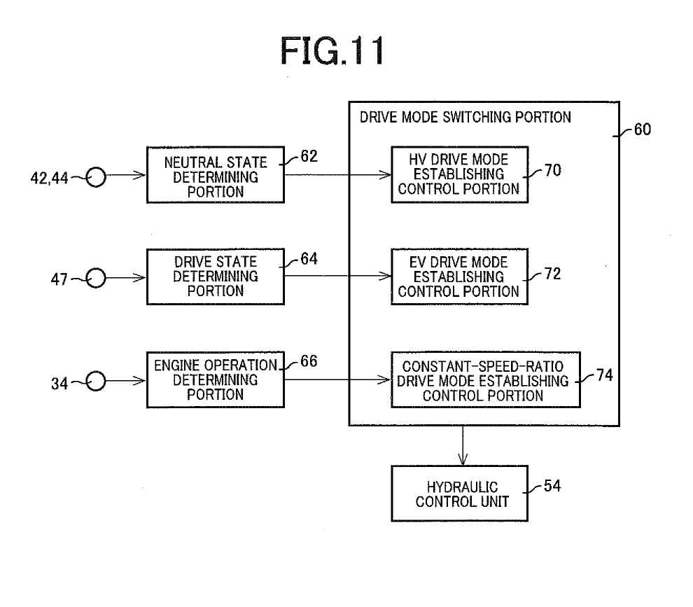

FIG. 11 is the functional block diagram illustrating major control functions of the electronic control device 30. A drive mode switching portion 60 shown in FIG. 11 is configured to determine the drive mode of the drive system 10 that should be established. Described more specifically, the drive mode switching portion 60 is basically configured to select one of the drive modes indicated in FIG. 3, so as to satisfy the required vehicle drive force with a high degree of fuel economy and so that the electric energy amount SOC stored in the battery 48 is maintained at a value not smaller than a predetermined lower limit. That is, the drive mode switching portion 60 selects one of the vehicle drive modes, on the basis of the accelerator pedal operation amount Acc detected by the accelerator pedal operation amount sensor 32, the vehicle running speed V corresponding to the output speed detected by the output speed sensor 40, the stored electric energy amount SOC of the battery 48 detected by the battery SOC sensor 46, etc., and according to a predetermined drive mode switching map.

When the drive system 10 is required to be switched to one of the electric motor drive modes EV1 and EV2 during running of the hybrid vehicle in one of the constant-speed-ratio drive modes “1st-speed” through “4th-speed” in which the engine 12 is operated, the drive mode switching portion 60 selects either one of the electric motor drive modes EV1 and EV2 depending upon the presently established constant-speed-ratio drive mode, so that the selected electric motor drive mode is rapidly established with a simple engaging or releasing action of the relevant one coupling element or simple engaging and releasing actions of the relevant two coupling elements. When the drive system 10 is required to be switched to one of the electric motor drive modes EV1 and EV2 during running of the hybrid vehicle in the constant-speed-ratio drive mode “1st-speed” or “2nd-speed”, for instance, the drive mode switching portion 60 selects the first electric motor drive mode EV1 and establishes the selected first electric motor drive mode EV1 by a simple releasing action of one coupling element, that is, a releasing action of the clutch CL1 or the brake BK1. When the drive system 10 is required to be switched to one of the electric motor drive modes EV1 and EV2 during running of the hybrid vehicle in the constant-speed-ratio drive mode “3rd-speed” or “4th-speed”, the drive mode switching portion 60 selects the second electric motor drive mode EV2 and establishes the selected second electric motor drive mode EV2 by a simple clutch-to-clutch switching action, that is, a releasing action of the clutch CL1 and an engaging action of the brake BK2, or a releasing action of the brake BK1 and an engaging action of the brake BK2.

The electronic control device 30 controls the operation of the engine 12 through the engine control device 52. For example, the electronic control device 30 commands the engine control device 52 to control: the amount of injection of a fuel by the fuel injecting device into the intake pipe of the engine 12; the timing of ignition of the engine 12 by the igniting device; and the opening angle θ_{TH} of the electronic throttle valve, so that the required output of the engine 12, that is, the target torque (target engine output) is obtained. The electronic control device 30 is further configured to temporarily reduce the output torque of the engine 12 while the vehicle drive mode is changed, so that a shifting shock of the drive system 10 is reduced.

The electronic control device 30 controls the operation of the first electric motor MG1 through the inverter 50. For example, the electronic control device 30 commands the inverter 50 to control an amount of electric energy to be supplied from the battery 48 to the first electric motor MG1, so that the required output of the first electric motor MG1, that is, the target torque (target MG1 output) is obtained. The electronic control device 30 controls the operation of the second electric motor MG2 through the inverter 50. Further, the electronic control device 30 commands the inverter 50 to control an amount of electric energy to be supplied from the battery 48 to the second electric motor MG2, so that the required output of the second electric motor MG2, that is, the target torque (target MG2 output) is obtained.

For running the hybrid vehicle in one of the hybrid drive modes HV1 and HV2 in which the engine 12 is operated while the first and second electric motors MG1 and MG2 are also operated as the vehicle drive power source, the electronic control device 30 calculates the drive force required to be generated by the drive system 10 (output gear 28), on the basis of the accelerator pedal operation amount Ace detected by the accelerator pedal operation amount sensor 32, and the vehicle running speed V corresponding to the output speed N_{OUT} detected by the output speed sensor 40. The electronic control device 30 commands an MG1 control portion and an MG2 control portion not shown, to control the operations of the first and second electric motors MG1 and MG2, and commands the engine control device 52 to control the operation of the engine 12, so that the required drive force of the drive system 10 is obtained by the output torque of the engine 12 and the output torques of the first and second electric motors MG1 and MG2.

A neutral state determining portion 62 shown in FIG. 11 is configured to determine whether the drive system 10 is placed in the neutral state in which a drive force is not transmitted through the power transmitting path from the engine 12 to the output gear 28, in the released states of all of the clutches CL1 and CL2 and brakes BK1 and BK2. For instance, this determination is made depending upon whether clutch engaging pressure detected by the clutch engaging pressure sensor 42 and brake engaging pressure detected by the brake engaging pressure sensor 44 are equal to the atmospheric pressure, for instance, whether the first and second electric motors MG1 and MG2 are held at rest, and/or whether the presently selected operating position (shift position) of the manually operated shifting device (shift lever) detected by the shift position sensor 47 is the neutral position N. A drive state determining portion 64 is configured to determine whether the drive system 10 is placed in any vehicle drive state. For instance, this determination is made depending upon whether the presently selected operating position of the manually operated shifting device detected by the shift position sensor 47 is a drive position D. An engine operation determining portion 66 is configured to determine whether the engine 12 is operated or not. For instance, this determination is made depending upon whether the engine speed N_{E} detected by the engine speed sensor 34 is zero.

An HV drive mode establishing control portion 70 is configured to select the hybrid drive mode HV1 or HV2 when the hybrid vehicle is required to be driven (accelerated) under a comparatively low load with an operation of the accelerator pedal while the drive system 10 is placed in the neutral state in which a drive force is not transmitted through the power transmitting path from the engine 12 to the output gear 28, in the released states of all of the four coupling elements, namely, in the released states of the clutches CL1 and CL2 and the brakes BK1 and BK2, and while the engine 12 is operated. The hybrid drive modes HV1 and HV2 are established by an engaging action of only one coupling element in the form of the clutch CL2 or brake BK2 performed with a synchronous control by the first electric motor MG1 and/or the second electric motor MG2. The HV drive mode establishing control portion 70 establishes the selected hybrid drive mode HV1 or HV2 by bringing the relevant clutch CL2 or brake BK2 into the engaged state, to drive the hybrid vehicle under the required load.

An EV drive mode establishing control portion 72 is configured to select the electric motor drive mode EV1 or EV2 when the hybrid vehicle is required to be driven (accelerated) under a comparatively low load with an operation of the accelerator pedal while the drive system 10 is placed in the neutral state and while the engine 12 is held at rest. The electric motor drive modes EV1 and EV2 are established by an engaging action of only one coupling element in the form of the clutch CL2 or brake BK2 performed with a synchronous control by the first electric motor MG1 and/or the second electric motor MG2. The EV drive mode establishing control portion 72 establishes the selected electric motor drive mode EV1 or EV2 by bringing the relevant clutch CL2 or brake BK2 into the engaged state, to drive the hybrid vehicle under the required load. Regarding the electric motor drive mode EV2 which is established by the engaging actions of the clutch CL2 and the brake BK2, as indicated in FIG. 3, it is noted that these clutch CL2 and brake BK2 are rotated at the same speed, and therefore one of these two coupling elements can be brought into the engaged state before the other coupling element is brought into the engaged state, so that the electric motor drive mode EV2 can be established by controlling only one coupling element, that is, the above-indicated other coupling element while the above-indicated one coupling element is placed in the engaged state.

A constant-speed-ratio drive mode establishing control portion 74 is configured to first select the hybrid drive mode HV1 or HV2 or the electric motor drive mode EV1 or EV2 when the hybrid vehicle is required to be driven (accelerated) in one of the constant-speed-ratio drive modes, under a comparatively high load or with a comparatively high degree of power transmitting efficiency while the drive system 10 is placed in the neutral state. As described above, each of the hybrid drive modes HV1 and HV2 and the electric motor drive modes EV1 and EV2 is established by an engaging action of only one coupling element in the form of the clutch CL2 or brake BK2 performed with a synchronous control by the first electric motor MG1 and/or the second electric motor MG2. The constant-speed-ratio drive mode establishing control portion 74 then selects and establishes the relevant constant-speed-ratio drive mode by bringing the relevant coupling element into the engaged state. When the drive system 10 is required to be placed in the constant-speed-ratio drive mode “1st-speed”, for example, the constant-speed-ratio drive mode establishing control portion 74 first establishes the first hybrid drive mode HV1 or the first electric motor drive mode EV1 by bringing only the brake BK2 into the engaged state, and then establishes the constant-speed-ratio drive mode “1st-speed” by bringing the clutch CL1 into the engaged state. When the drive system 10 is required to be placed in the constant-speed-ratio drive mode “2nd-speed”, the constant-speed-ratio drive mode establishing control portion 74 first establishes the first hybrid drive mode HV1 or the first electric motor drive mode EV1 by bringing only the brake BK2 into the engaged state, and then establishes the constant-speed-ratio drive mode “2nd-speed” by bringing the brake BK1 into the engaged state. When the drive system 10 is required to be placed in the constant-speed-ratio drive mode “3rd-speed”, the constant-speed-ratio drive mode establishing control portion 74 first establishes the second hybrid drive mode HV2 or the second electric motor drive mode EV2 by bringing only the clutch CL2 into the engaged state, and then establishes the constant-speed-ratio drive mode “3rd-speed” by bringing the clutch CL1 into the engaged state. When the drive system 10 is required to be placed in the constant-speed-ratio drive mode “4th-speed”, the constant-speed-ratio drive mode establishing control portion 74 first establishes the second hybrid drive mode HV2 or the second electric motor drive mode EV2 by bringing only the clutch CL2 into the engaged state, and then establishes the constant-speed-ratio drive mode “4th-speed” by bringing the brake BK1 into the engaged state.

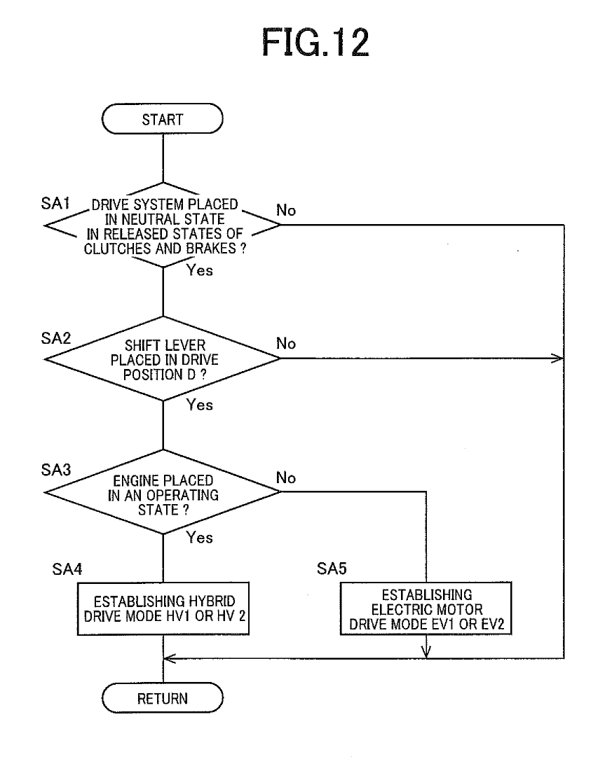

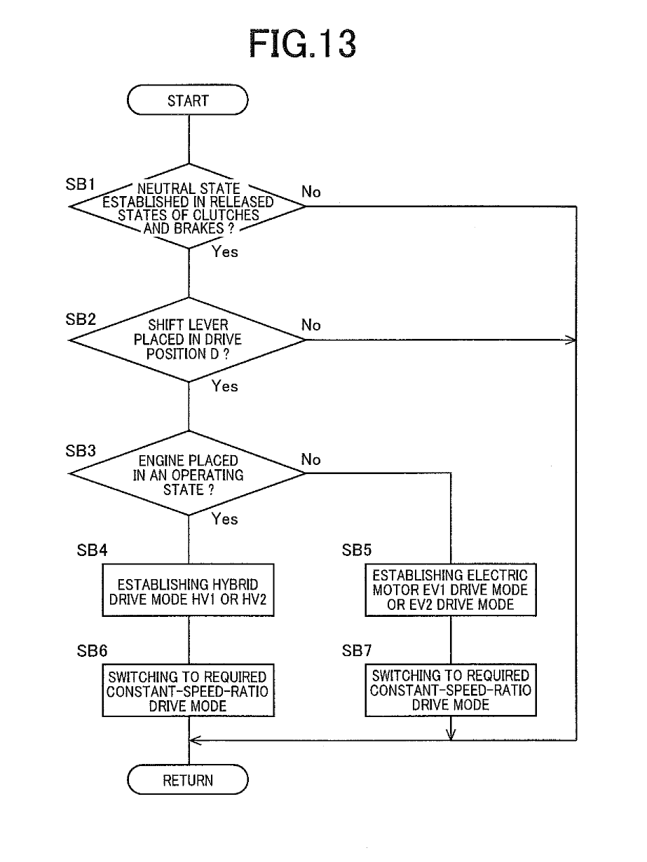

FIGS. 12 and 13 are the flow charts illustrating major portions of respective two examples of a drive mode switching control implemented by the electronic control device 30. The drive mode switching controls of these flow charts are implemented with a predetermined cycle time. Steps implemented in the drive mode switching controls correspond to an operation of the drive mode switching portion 60. The drive mode switching control of FIG. 12 is implemented when the hybrid vehicle is required to be driven (accelerated) under a comparatively low load with an operation of the accelerator pedal while the drive system 10 is placed in the neutral state, and the drive mode switching control of FIG. 13 is implemented when the hybrid vehicle is required to be driven (accelerated) under a comparatively high load with an operation of the accelerator pedal while the drive system 10 is placed in the neutral state.

The drive mode switching control illustrated in the flow chart of FIG. 12 is initiated with a step SA1 corresponding to the neutral state determining portion 62, to determine whether the drive system 10 is placed in the neutral state in which the drive force is not transmitted through the power transmitting path from the engine 12 to the output gear 28 in the released states of the clutches CL1 and CL2 and the brakes BK1 and BK2. For instance, this determination is made depending upon whether the clutch engaging pressure detected by the clutch engaging pressure sensor 42 and the brake engaging pressure detected by the brake engaging pressure sensor 44 are equal to the atmospheric pressure, for instance, whether the first and second electric motors MG1 and MG2 are held at rest, and/or whether the presently selected operating position (shift position) of the manually operated shifting device (shift lever) detected by the shift position sensor 47 is the neutral position N. If a negative determination is obtained in the step SA1, the present routine is terminated. If an affirmative determination is obtained in the step SA1, the control flow goes to a step SA2 corresponding to the drive state determining portion 64, to determine whether the drive system 10 is placed in any vehicle drive state. For instance, this determination is made depending upon whether the presently selected operating position of the manually operated shifting device detected by the shift position sensor 47 is the drive position D. If a negative determination is obtained in the step SA2, the present routine is terminated. If an affirmative determination is obtained in the step SA2, the control flow goes to a step SA3 corresponding to the engine operation determining portion 66, to determine whether the engine 12 is operated or not. For instance, this determination is made depending upon whether the engine speed NE detected by the engine speed sensor 34 is zero.

An affirmative determination obtained in the step SA3 indicates that the hybrid vehicle is required to be driven (accelerated) under a comparatively low load with an operation of the accelerator pedal while the drive system 10 is placed in the neutral state and while the engine 12 is operated. If the affirmative determination is obtained in the step SA3, therefore, the control flow goes to a step SA4 corresponding to the HV drive mode establishing control portion 70, to select the hybrid drive mode HV1 or HV2 which is established by an engaging action of only one coupling element in the form of the clutch CL2 or brake BK2 performed with a synchronous control by the first electric motor MG1 and/or the second electric motor MG2. Namely, the drive system 10 is switched to the selected hybrid drive mode HV1 or HV2 by bringing the relevant clutch CL2 or brake BK2 into the engaged state, to drive the hybrid vehicle under the required load.

A negative determination obtained in the step SA3 indicates that the hybrid vehicle is required to be driven (accelerated) under a comparatively low load without an operation of the accelerator pedal while the drive system 10 is placed in the neutral state and while the engine 12 is held at rest. If the negative determination is obtained in the step SA3, therefore, the control flow goes to a step SA5 corresponding to the EV drive mode establishing control portion 72, to select the electric motor drive mode EV1 or EV2 which is established by an engaging action of only one coupling element in the form of the clutch CL2 or brake BK2 performed with a synchronous control by the first electric motor MG1 and/or the second electric motor MG2. Namely, the drive system 10 is switched to the selected electric motor drive mode EV1 or EV2 by bringing the brake BK2 into the engaged state, or bringing the clutch CL2 into the engaged state after an engaging action of the brake BK2, to drive the hybrid vehicle under the required load.

The drive mode switching control illustrated in the flow chart of FIG. 13 is implemented when the hybrid vehicle is required to be driven (accelerated) under a comparatively high load with an operation of the accelerator pedal while the drive system 10 is placed in the neutral state. Steps SB1-SB5 in this drive mode switching control of FIG. 13 are identical with the steps SA1-SA5 in the drive mode switching control of FIG. 12. The drive mode switching control of FIG. 12 is different from that of FIG. 13 in that the steps SB4 and SB5 are followed by respective steps SB6 and SB7 in the drive mode switching control of FIG. 13. It is noted that the steps SB4-SB7 correspond to an operation of the constant-speed-ratio drive mode establishing control portion 74.

In the step SB4 implemented while the engine 12 is operated, the drive system 10 is once switched to either one of the hybrid drive modes HV1 and HV2. Preferably, however, the drive system 10 is once switched to one of the hybrid drive modes HV1 and HV2 which is selected according to one of the constant-speed-ratio drive modes “1st-speed” through “4th-speed” which is required to be eventually established. Where the drive system 10 is required to be eventually switched to the constant-speed-ratio drive mode “1st-speed” or “2nd-speed”, for example, the drive system 10 is once switched to the first hybrid drive mode HV1 by bringing the brake BK2 into the engaged state. Where the drive system 10 is required to be eventually switched to the constant-speed-ratio drive mode “3rd-speed” or “4th-speed”, the drive system 10 is once switched to the second hybrid drive mode HV2 by bringing the clutch CL2 into the engaged state. Each of these first and second hybrid drive modes HV1 and HV2 is established by an engaging action of only one coupling element in the form of the clutch CL2 or brake BK2 performed with a synchronous control by the first electric motor MG1 and/or the second electric motor MG2.

In the step SB6 implemented after the step SB4, the coupling element for establishing the desired constant-speed-ratio drive mode is brought into the engaged state. Where the constant-speed-ratio drive mode “1st-speed” is required to be established, for instance, the clutch CL1 is brought into the engaged state in the step SB6 to establish the constant-speed-ratio drive mode “1st-speed” after the brake BK2 has been brought into the engaged state in the step SB4. Where the constant-speed-ratio drive mode “2nd-speed” is required to be established, the brake BK1 is brought into the engaged state in the step SB6 to establish the constant-speed-ratio drive mode “2nd-speed” after the brake BK2 has been brought into the engaged state in the step SB4. Where the constant-speed-ratio drive mode “3rd-speed” is required to be established, the clutch CL1 is brought into the engaged state in the step SB6 to establish the constant-speed-ratio drive mode “3rd-speed” after the clutch CL2 has been brought into the engaged state in the step SB4. Where the constant-speed-ratio drive mode “4th-speed” is required to be established, the brake BK1 is brought into the engaged state in the step SB6 to establish the constant-speed-ratio drive mode “4th-speed” after the clutch CL2 has been brought into the engaged state in the step SB4. Each of the constant-speed-ratio drive modes “1st-speed” through “4th-speed” is established by an engaging action of only one coupling element in the form of the clutch CL1 or brake BK1 performed with a synchronous control by the first electric motor MG1 and/or the second electric motor MG2.

In the step SB5 implemented while the engine 12 is held at rest, the drive system 10 is once switched to either one of the electric motor drive modes EV1 and EV2. Preferably, however, the drive system 10 is once switched to one of the electric motor drive modes EV1 and EV2 which is selected according to one of the constant-speed-ratio drive modes “1st-speed” through “4th-speed” which is required to be eventually established. Where the drive system 10 is required to be eventually switched to the constant-speed-ratio drive mode “1st-speed” or “2nd-speed”, for example, the drive system 10 is once switched to the first electric motor drive mode EV1 by bringing the brake BK2 into the engaged state. Where the drive system 10 is required to be eventually switched to the constant-speed-ratio drive mode “3rd-speed” or “4th-speed”, the drive system 10 is once switched to the second electric motor drive mode EV2 by bringing the brake BK2 into the engaged state or by bringing the clutch CL2 into the engaged state after the engaging action of the brake BK2. Each of these first and second electric motor drive modes EV1 and EV2 is established by an engaging action of only one coupling element in the form of the brake BK2 or clutch CL2 performed with a synchronous control by the first electric motor MG1 and/or the second electric motor MG2.

In the step SB7 implemented after the step SB5, the coupling element for establishing the desired constant-speed-ratio drive mode is brought into the engaged state. Where the constant-speed-ratio drive mode “1st-speed” is required to be established, for instance, the clutch CL1 is brought into the engaged state in the step SB7 to establish the constant-speed-ratio drive mode “1st-speed” after the brake BK2 has been brought into the engaged state in the step SB5. Where the constant-speed-ratio drive mode “2nd-speed” is required to be established, the brake BK1 is brought into the engaged state in the step SB7 to establish the constant-speed-ratio drive mode “2nd-speed” after the brake BK2 has been brought into the engaged state in the step SB5. Where the constant-speed-ratio drive mode “3rd-speed” is required to be established, the brake BK2 is brought into the released state and the clutch CL1 is brought into the engaged state in the step SB7 to establish the constant-speed-ratio drive mode “3rd-speed” after the clutch CL2 has been brought into the engaged state in the step SB5. Where the constant-speed-ratio drive mode “4th-speed” is required to be established, the brake BK2 is brought into the released state and the brake BK1 is brought into the engaged state in the step SB7 to establish the constant-speed-ratio drive mode “4th-speed” after the clutch CL2 has been brought into the engaged state in the step SB5. Each of the constant-speed-ratio drive modes “1st-speed” through “4th-speed” is established by an engaging action of only one coupling element in the form of the clutch CL1 or brake BK1 performed with a synchronous control by the first electric motor MG1 and/or the second electric motor MG2.

In the present embodiment described above, a control apparatus in the form of the electronic control device 30 for the hybrid vehicle drive system 10 comprises the drive mode switching portion 60 which is configured to establish one of the plurality of hybrid drive modes HV1 and HV2 and the plurality of electric motor drive modes EV1 and EV2, with an engaging action of one of the plurality of coupling elements in the form of the clutches CL1 and CL2 and the brakes BK1 and BK2, when the drive system 10 is required to be switched from the neutral state to any vehicle drive state while the hybrid vehicle is held stationary or running. Described more specifically, where the drive system 10 is required to be switched from the neutral state to the vehicle drive state while the engine 12 is operated, an engaging action of one of the coupling elements permits the drive system 10 to be placed in one of the hybrid drive modes in which the drive system 10 is operated as an electrically controlled continuously variable transmission, at a speed ratio at which the engaging action of the relevant coupling element is easily coordinated with the operating speed NE of the engine 12 and can be performed with a reduced amount of engaging shock, with a synchronous control by the first electric motor MG1 and/or the second electric motor MG2. Where the drive system 10 is required to be switched from the neutral state to the vehicle drive state while the engine 12 is held at rest, an engaging action of one of the coupling elements permits the drive system 10 to be placed in one of the electric motor drive modes in which the engaging action of the relevant coupling element is not required to be coordinated with the operating speed NE of the engine 12. Accordingly, the risk of generation of the engaging shock of the relevant coupling element upon switching of the drive system from the neutral state to any vehicle drive state can be effectively reduced, with the synchronous control by the first electric motor MG1 and/or the second electric motor MG2.

The drive mode switching portion 60 is further configured to establish one of the plurality of hybrid drive modes HV1 and HV2 when the drive system 10 is required to be switched from the neutral state to the vehicle drive state while the engine 12 is operated. Accordingly, where the drive system 10 is required to be switched from the neutral state to the vehicle drive state while the engine 12 is operated, one of the coupling elements (clutches CL1 and CL2, and brakes BK1 and BK2) is brought into the engaged state to place the drive system 10 in one of the hybrid drive modes HV1 and HV2 in which the drive system 10 is operated as an electrically controlled continuously variable transmission, at a speed ratio at which the engaging action of the relevant coupling element is easily coordinated with the operating speed N_{E} of the engine 12 and can be performed with a reduced amount of engaging shock. Thus, the risk of generation of the engaging shock of the relevant coupling element upon switching of the drive system 10 from the neutral state to any vehicle drive state can be effectively reduced.

The drive mode switching portion 60 is also configured to establish one of the plurality of electric motor drive modes EV1 and EV2 when the drive system 10 is required to be switched from the neutral state to the vehicle drive state while the engine 12 is held at rest. Accordingly, where the drive system 10 is required to be switched from the neutral state to the vehicle drive state while the engine 12 is held at rest, one of the coupling elements (clutches CL1 and CL2 and brakes BK1 and BK2) is brought into the engaged state to place the drive system 10 in one of the electric motor drive modes EV1 and EV2 in which the engaging action of the relevant coupling element is not required to be coordinated with the operating speed NE of the engine 12. Thus, the risk of generation of the engaging shock of the relevant coupling element upon switching of the drive system 10 from the neutral state to any vehicle drive state can be effectively reduced with the synchronous control by the first electric motor MG1 and/or the second electric motor MG2.

The illustrated hybrid vehicle drive system 10 can be selectively placed not only in one of the hybrid drive modes HV1 and HV2 and the electric motor drive modes EV1 and EV2, with an engaging action of one of the coupling elements (clutches CL1 and CL2 and brakes BK1 and BK2), but also in one of the constant-speed-ratio drive modes “1st-speed” through “4th-speed” having the respective different speed ratios, with an engaging action of another coupling element as well as or in place of the above-indicated one coupling element. When the drive system 10 is required to be switched from the neutral state to one of the plurality of constant-speed-ratio drive modes “1st-speed” through “4th-speed”, the drive mode switching portion 60 once establishes one of the plurality of electric motor drive modes EV1 and EV2 and the plurality of hybrid drive modes HV1 and HV2, and then eventually establishes the above-indicated one of the plurality of constant-speed-ratio drive modes “1st-speed” through “4th-speed”. Namely, the drive system 10 which is required to be switched to one of the constant-speed-ratio drive modes is once placed in one of the electric motor drive modes EV1 and HV2 and the hybrid drive modes HV1 and HV2, before the drive system 10 is eventually placed in the required constant-speed-ratio drive mode, so that the engaging shock upon initial switching of the drive system 10 to the above-indicated one of the electric motor drive modes and the hybrid drive modes can be reduced, and the engaging shock upon subsequent switching of the drive system 10 to the required constant-speed-ratio drive mode with the engaging action of the above-indicated another coupling element can also be reduced since the engaging action of the above-indicated another coupling element can be easily synchronized with the synchronous control by the first electric motor MG1 and/or the second electric motor MG2.

In the illustrated drive system 10, the first hybrid drive mode HV1 and the second hybrid drive mode HV2 are provided as the hybrid drive modes, and the first electric motor drive mode EV1 and the second electric motor drive mode EV2 are provided as the electric motor drive modes, while the constant-speed-ratio drive modes “1st-speed” through “4th-speed” are proved as the first, second, third and fourth speed constant-speed-ratio drive modes which have respective different speed ratio values which decrease in the direction from the first speed constant-speed-ratio drive mode toward the fourth speed constant-speed-ratio drive mode. Further, the coupling elements provided in the illustrated drive system 10 include: a first coupling element in the form of the brake BK2 which is placed in an engaged state to establish the first hybrid drive mode HV1 while the engine 12 is operated, and the first electric motor drive mode EV1 while the engine 12 is held at rest; a second coupling element in the form of the clutch CL2 which is placed in an engaged state to establish the second hybrid drive mode HV2 while the engine 12 is operated, and the second electric motor drive mode EV2 while the engine 12 is held at rest; a third coupling element in the form of the clutch CL1 which is placed in an engaged state in the engaged state of the first coupling element, to establish the first speed constant-speed-ratio drive mode, and in an engaged state of the second coupling element, to establish the third speed constant-speed-ratio drive mode; and a fourth coupling element in the form of the brake BK1 which is placed in an engaged state in the engaged state of the first coupling element, to establish the second speed constant-speed-ratio drive mode, and in the engaged state of the second coupling element, to establish the fourth speed constant-speed-ratio drive mode. Accordingly, the drive system 10 is switched from the neutral state to one of the hybrid drive modes HV1 and HV2 and the electric motor drive modes EV1 and EV2, with an engaging action of the first or second coupling element BK2 and CL2, depending upon whether the engine 12 is operated or held at rest, and to one of the first through fourth speed constant-speed-ratio drive modes, with engaging actions of a corresponding one of four combinations of two coupling elements one of which is selected from the first and second coupling elements BK2 and CL2 and the other of which is selected from the third and fourth coupling elements CL1 and KB1.

The present hybrid vehicle drive system 10 is arranged such that (a) each of the first differential mechanism in the form of the first planetary gear set 14 and the second differential mechanism in the form of the second planetary gear set 16 includes three rotary elements, and the first and second differential mechanisms are configured such that one of the three rotary elements of the first differential mechanism and one of the three rotary elements of the second differential mechanism are connected to each other, (b) the engine 12 and the first electric motor MG1 are respectively connected to two rotary elements of the three rotary elements of the first differential mechanism, which two rotary elements are not connected to the above-indicated one of the three rotary elements of the second differential mechanism, (c) the second electric motor MG2 is connected to the above-indicated one of the three rotary elements of the second differential mechanism, (d) the output rotary member in the form of the output gear 28 is connected to one of two rotary elements of the second differential mechanism, which two rotary elements are not connected to the above-indicated one of the three rotary elements of the first differential mechanism, and (e) the plurality of coupling elements in the form of the clutches CL1 and CL2 and brakes BK1 and BK2 include: a first clutch element in the form of the clutch CL1 for selectively connecting the two rotary elements (carrier C1 and ring gear R1) of the three rotary elements (sun gear S1, carrier C1 and ring gear R1) of the first differential mechanism to each other; a second clutch element in the form of the clutch CL2 for selectively connecting the rotary element (carrier C1) of the first differential mechanism connected to the engine 12 and the other (ring gear R2) of the two rotary elements (carrier C2 and ring gear R2) of the second differential mechanism to each other; a first brake element in the form of the brake BK1 for selectively connecting the rotary element (ring gear R1) of the first differential mechanism connected to the first electric motor MG1 to the stationary member in the form of the housing 26; and a second brake element in the form of the brake BK2 for selectively connecting the other (ring gear R2) of the two rotary elements of the second differential mechanism to the stationary member. The drive mode switching portion 60 is configured to establish the first electric motor drive mode EV1 with the engaging action of the second brake element, establish the second electric motor drive mode EV2 with the engaging action of the second clutch element, establish the constant-speed-ratio drive mode “1st-speed” with the engaging actions of the first clutch element and the second brake element, establish the constant-speed-ratio drive mode “2nd-speed” with the engaging actions of the first brake element and the second brake element, establish the constant-speed-ratio drive mode “3rd-speed” with the engaging actions of the first clutch element and the second clutch element, and establish the constant-speed-ratio drive mode “4th-speed” with the engaging actions of the second clutch element and the first brake element.

In the drive system 10 arranged as described above, the drive mode switching portion 60 is configured to once establish the first electric motor drive mode EV1 when the drive system 10 is required to establish the motor drive mode during the constant-speed-ratio drive mode “1st-speed” or “2nd-speed”, and to once establish the second electric motor drive mode EV2 when the drive system 10 is required to establish the motor drive mode during the constant-speed-ratio drive mode “3rd-speed” or “4th-speed”. Thus, the first or second electric motor drive mode EV1 or EV2 is once established with a releasing action of only one coupling element when the drive system 10 is in any one of the four constant-speed-ratio drive modes “1st-speed” through “4th-speed”. Accordingly, the drive system 10 can be smoothly and rapidly switched from the any one of the constant-speed-ratio drive modes in which the hybrid vehicle is driven by the engine 12 operated as a vehicle drive power source in response to a request for the motor drive mode, so that deterioration of drivability of the hybrid vehicle upon switching of the drive system 10 to the desired constant-speed-ratio drive mode can be reduced.

Although the four constant-speed-ratio drive modes “1st-speed” through “4th-speed” are available in the illustrated hybrid vehicle drive system 10, the present invention is equally applicable to a hybrid vehicle drive system having no more than four constant-speed-ratio drive modes, or five or more constant-speed-ratio drive modes. The hybrid vehicle drive system 10 may be provided with an additional transmission device so that five or more constant-speed-ratio drive modes are available.

While the preferred embodiment of this invention has been described by reference to the drawings, it is to be understood that the invention is not limited to the details of the illustrated embodiments, but may be embodied with various changes which may occur without departing from the spirit of the invention.

### NOMENCLATURE OF REFERENCE SIGNS

10: Hybrid vehicle drive system
12: Engine
14: First planetary gear set (First differential mechanism)
16: Second planetary gear set (Second differential mechanism)
26: Housing (Stationary member)
28: Output gear (Output rotary member)
30: Electronic control device
BK1: Brake (Fourth coupling element; First brake element)
BK2: Brake (First coupling element; Second brake element)
CL1: Clutch (Third coupling element; First clutch element)
CL2: Clutch (Second coupling element; Second clutch element)
MG1: First electric motor
MG2: Second electric motor
S1: Sun gear (Rotary element)
C1: Carrier (Rotary element)
R1: Ring gear (Rotary element)
S2: Sun gear (Rotary element)
C2: Carrier (Rotary element)
R2: Ring gear (Rotary element)

WHAT IS CLAIMED IS;

1. A control apparatus for a drive system of a hybrid vehicle including: a differential device which comprises a first differential mechanism and a second differential mechanism and which comprises four rotary components; an engine, a first electric motor, a second electric motor and an output rotary member which are respectively connected to the four rotary components; and a plurality of coupling elements which selectively connect selected ones of the rotary components and a stationary member to each other, and which permit the hybrid vehicle drive system to be placed in a selected one of an electric motor drive mode in which at least one of said first and second electric motors is operated as a vehicle drive power source, and a plurality of constant-speed-ratio drive modes in which the engine is operated as the vehicle drive power source and which have respective different speed ratio values, the control apparatus being configured to selectively establish one of a hybrid drive mode and said electric motor drive mode, with an engaging action of one of said plurality of coupling elements, and one of said plurality of constant-speed-ratio drive modes, with an engaging action of another of said plurality of coupling elements as well as or in place of the engaging action of said one coupling element, the control apparatus comprising:
a drive mode switching portion configured to establish one of said hybrid drive mode and said electric motor drive mode, when said drive system is required to be switched from a neutral state in which a drive force is not transmitted through a power transmitting path with all of said plurality of coupling elements being placed in released states, to a vehicle drive state in which the drive force is transmitted through the power transmitting path.

2. The control apparatus according to claim 1, wherein said drive mode switching portion establishes said hybrid drive mode when the drive system is required to be switched from said neutral state to said vehicle drive state while said engine is operated.

3. The control apparatus according to claim 1, wherein said drive mode switching portion establishes said electric motor drive mode when the drive system is required to be switched from said neutral state to said vehicle drive state while said engine is held at rest.

4. The control apparatus according to claim 1, wherein when the drive system is required to be switched from said neutral state to one of said plurality of constant-speed-ratio drive modes, the drive mode switching portion once establishes one of said electric motor drive mode and said hybrid drive mode, and then eventually establishes said one of the plurality of constant-speed-ratio drive modes.

5. The control apparatus according to claim 1, wherein said hybrid drive mode includes a first hybrid drive mode and a second hybrid drive mode, and said electric motor drive mode includes a first electric motor drive mode and a second electric motor drive mode, while said plurality of constant-speed-ratio drive modes include a first speed constant-speed-ratio drive mode, a second speed constant-speed-ratio drive mode, a third speed constant-speed-ratio drive mode, and a fourth speed constant-speed-ratio drive mode, which have respective different speed ratio values which decrease in a direction from said first speed constant-speed-ratio drive mode toward said fourth speed constant-speed-ratio drive mode,
and wherein said plurality of coupling elements include: a first coupling element which is placed in an engaged state to establish said first hybrid drive mode while said engine is operated, and said first electric motor drive mode while said engine is held at rest; a second coupling element which is placed in an engaged state to establish said second hybrid drive mode while said engine is operated, and said second electric motor drive mode while said engine is held at rest; a third coupling element which is placed in an engaged state in the engaged state of said first coupling element, to establish said first speed constant-speed-ratio drive mode, and in the engaged state of said second coupling element, to establish said third speed constant-speed-ratio drive mode; and a fourth coupling element which is placed in an engaged state in the engaged state of said first coupling element, to establish said second speed constant-speed-ratio drive mode, and in the engaged state of said second coupling element, to establish said fourth speed constant-speed-ratio drive mode.

6. The control apparatus according to claim 1, wherein each of said first differential mechanism and said second differential mechanism includes three rotary elements, and said first and second differential mechanisms are configured such that one of said three rotary elements of said first differential mechanism and one of said three rotary elements of said second differential mechanism are connected to each other;
said engine and said first electric motor being respectively connected to two rotary elements of said three rotary elements of said first differential mechanism, which two rotary elements are not connected to said one of said three rotary elements of said second differential mechanism;
said second electric motor being connected to said one of said three rotary elements of said second differential mechanism;
said output rotary member being connected to one of two rotary elements of said second differential mechanism, which two rotary elements are not connected to said one of said three rotary elements of said first differential mechanism;
said plurality of coupling elements including: a first clutch element for selectively connecting said two rotary elements of said three rotary elements of said first differential mechanism to each other; a second clutch element for selectively connecting the rotary element of said first differential mechanism connected to said engine and the other of said two rotary elements of said second differential mechanism to each other; a first brake element for selectively connecting the rotary element of said first differential mechanism connected to said first electric motor to a stationary member; and a second brake element for selectively connecting the other of said two rotary elements of said second differential mechanism to said stationary member;
and wherein said drive mode switching portion establishes a first one of said electric motor drive modes with an engaging action of said second brake element, establishes a second one of the electric motor drive modes with an engaging action of said second clutch element, establishes a first-speed one of said constant-speed-ratio drive modes with engaging actions of said first clutch element and said second brake element, establishes a second-speed one of said constant-speed-ratio drive modes with engaging actions of said first brake element and said second brake element, establishes a third-speed one of said constant-speed-ratio drive modes with engaging actions of said first clutch element and said second clutch element, and establishes a fourth-speed one of said constant-speed-ratio drive modes with engaging actions of said second clutch element and said first brake element.
